(19) United States
(12) Patent Application Publication
(10) Pub. No.: US 2015/0256350 A1
(43) Pub. Date: Sep. 10, 2015

(54) Smartphone Application for Establishing Local Social Networks on the Internet

(71) Applicant: Rami Cohen, Tel Aviv (IL)

(72) Inventor: Rami Cohen, Tel Aviv (IL)

(21) Appl. No.: 14/195,876

(22) Filed: Mar. 4, 2014

(51) Int. Cl. H04L 12/18

(52) U.S. Cl. CPC H04L 12/1813

(57) ABSTRACT

A system that includes a smartphone application that enables any individual to establish a local social network on the internet. The system includes a website management system that enables the user to manage and design the local social network's website. The system sends the network administrator a quick response code that potential network users may use to log in to the said network. The system enables the administrator to define the geographic boundaries of the local area within which users may log in to the network and interact on it. The system enables the general public to log in to the said network using a smartphone and a quick response code only if they are located physically within the local area.

### TECHNICAL FIELD

The present invention refers to a smartphone application that enables any individual to establish a local social network that other users can log in to and use only if they are physically located within a certain area that is predefined by the administrator of the said network.

### BACKGROUND ART

Many social networks and websites exist today where users can meet strangers and interact with them online for a wide variety of purposes: business, exchange of information on specialty topics, romantic acquaintance, and so on. Such websites will hereinafter be referred to here as “social networks”. In most cases, people who log in to social networks are physically located in places that are remote from one another, in distant cities or even in different countries. Nevertheless, people have both a professional and a human need to connect with strangers who are located in their close vicinity, such as in the same restaurant, coffee shop, conference hall, hotel, swimming pool, park, university, residential block, and so on. The present invention offers a good and effective response to the said need.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 presents a schematic depiction of the system (1), the application (2), the server (21), several users' smartphones (3), a quick response code (4), a local social network (5) and local area (6).

### THE INVENTION

Present day smartphones and tablets offer the option of surfing the internet, which until relatively recently was an activity reserved exclusively for stationary, table-top computers. The option of surfing the internet almost anywhere using a device that almost everyone possesses constituted a significant technological revolution and enabled to provide various, innovative website services.

In order to facilitate the understanding of the system, subject of the present patent application, we will use the term “smartphone” to refer to a broad variety of mobile devices that can be used to connect to the internet, such as iPhones, smartphones, iPods and tablets.

The system (1), subject of the present invention, refers to the field of internet applications (2) for smartphones (3). The systems enables any individual to establish a local social network (5) to which users can log in and use only if they are within a certain geographic area (hereinafter “the local area”) (6). The person initiating the establishment of a specific local social network will be hereinafter referred to as “the administrator” and the people in the local area who are interested in logging in to the local social network and using it will be referred to as “the users”. The local social network (5) includes the word “local” because a use may log in to the local social network and use it only he or she is physically located within the local area. Furthermore, when a user who is located within the local area and is logged in to the said network leaves the local area, he or she will be automatically disconnected from the said network.

The defined limits of the local area are determined by the administrator at his or her sole discretion, although it is possible to define the system so that it restricts the maximal radius of the local area. The local area is defined by the administrator when he or she logs in to the server (21) that hosts and runs the application (2), subject of the system (hereinafter “the server”). When the administrator establishes the local social network, he or she must select a certain geographic area, i.e. the local area, whereby only people located within in the selected area may log in to the said network and may remain connected only as long as they are physically located within the local area. In order to establish the local social network, the administrator must hold his or her smartphone, stand in the middle of the area he or she wishes to define as the local area, and define the operative radius of the said network. The system (1) may include a default radius for cases in which the administrator prefers not to select a defined area.

Upon his or her first entry into the application, subject of the system, the administrator is referred to a website (hereinafter “the website”) through which, the administrator uses a site management operating system, which is integrated into the server, to erect, design and define the specific local social network. The server allocates the administrator some space on the server to run and store the said network, and issues the administrator a quick response code (4) that is used to manage the local social network, change the local area boundaries, upload content, and design and determine the structure of the said local social network.

The administrator also receives a quick response code that any person located within the local area can use in order to log in to the said network and use it. A quick response code is a code that can be printed as a barcode that when scanned using a smartphone, directs the user to the relevant webpage of the said social network. The administrator can print the quick response code on a billboard or elsewhere so that any person who enters the local area can see the quick response code and know that he or she may log in to the said local social network by scanning or inputting the said quick response code.

The system, subject of the present invention, may be used in a wide variety of ways. For example (a) owners of restaurants, coffee shops, etc. may establish local social networks, whose local areas are the premises of the restaurant or coffee shop. In such case, they may print the quick response code on the establishment's menu or in any other visible place in the restaurant or coffee shop and their customers may then log in to the said network. Thus, for instance, if two customers interact through the said network and decide to meet, they may introduce themselves to one another at that moment and in that place; or (b) a company that is holding a professional conference in a conference hall may establish a local social network whereby the conference participants may interact through the local social network before deciding to meet each other in person. Interacting through the said network may replace the numerous “small-talk interactions” people have at conferences until they identify and locate those people with whom they wish to establish deeper, more meaningful professional relationships. Using the said network at conferences, people can selectively and quickly make the acquaintance of a large number of people and immediately after interacting through the said network they may decide whom they wish to meet with in person; or (c) local social networks may be established at sports grounds, parks and open places where gatherings and competitions take place, at hotels, gyms, universities, and even in residential neighborhoods and the like.

Network administrators can design and build their specific local social network according to the nature of the said network and its objectives: romantic acquaintances, professional meetings, meetings to exchange experiences and information, social and political purposes, and so on. The methods of designing and building such social networks websites are known to any expert in the field and there is no need to elaborate on them in the present patent application. Nevertheless, it is noted that the said networks can and should enable their users to choose whether to act anonymously or in an identifiable manner, and should offer the users the option of adding personal data and general background information alongside their username of choice, as well as links to the personal pages on existing social networks such as Facebook, etc. In addition, the interactions between users on the network may be public or private, all according to the users' desires and the possibilities the network administrator enables when designing and building the said network as mentioned.

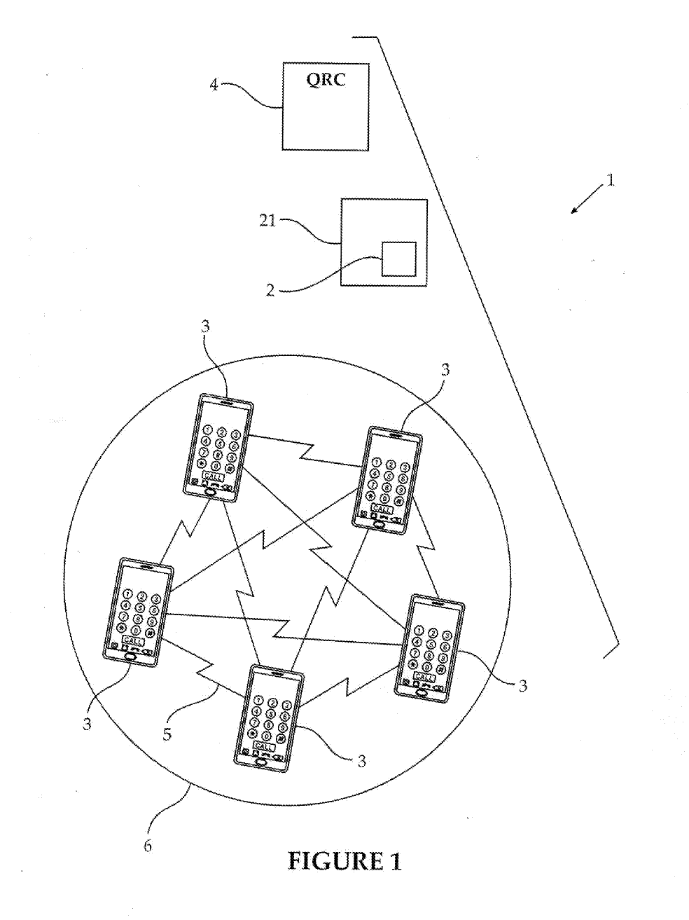

Potential users who have not seen any local advertising of the quick response code can also log in to the application without using a quick response code of a specific network, and may choose whether to establish a new local social network or to check whether there are any local social networks active at that specific location. FIG. 1 presents a schematic depiction of the system (1), the application (2), the server (21), several users' smartphones (3), a quick response code (4), a local social network (5) and local area (6).

What is claimed is:

1. A system that includes a smartphone application that enables any individual to establish a local social network; whereby the system includes a website management system that enables the user to manage and design the local social network's website; whereby the system sends the network administrator a quick response code that potential network users may use to log in to the said network; whereby the system enables the administrator to define the geographic boundaries of the local area within which users may log in the said network and interact on it; and whereby the system enables the general public to log in to the said network using a smartphone and the quick response code only if they are physically located within the local area.

2. The system described in claim No. 1 whereby the system also allocates the network's administrator space on a server in order to run and store said network; and whereby the system sends the administrator's smartphone a main quick response code that enables him or her to operate and design said network.
